(19) United States
(12) Patent Application Publication
(10) Pub. No.: US 2014/0099251 A1
(43) Pub. Date: Apr. 10, 2014

(54) Method for preparing of spinel lithium titanium oxide nanofiber for negative electrode of lithium secondary battery

(71) Applicant: Dongguk University Industry-Academic Cooperation Foundation, (US)

(72) Inventors: YONG-MOOK KANG, Seoul (KR); MI-RU JO, Seoul (KR)

(73) Assignee: Dongguk University Industry-Academic Cooperation Foundation, Seoul (KR)

(21) Appl. No.: 13/870,268

(22) Filed: Apr. 25, 2013

(30) Foreign Application Priority Data
Oct. 5, 2012 (KR) 10-2012-0110823

(51) Int. Cl. C01G 23/04; H01M 4/485

(52) U.S. Cl. CPC C01G 23/04; H01M 4/485
USPC 423/598; 264/10

(57) ABSTRACT

Disclosed is a method of preparing spinel lithium titanium oxide nanofibers for a negative electrode of a lithium secondary battery, including (S1) mixing an organic material selected from the group consisting of polyvinylpyrrolidone, polymethylmethacrylate, polyethylene, polyethylene oxide and polyvinyl alcohol, a lithium precursor, and a titanium precursor with a solvent, thus preparing a mixture solution, (S2) electrospinning the mixture solution, thus preparing composite nanofibers, and (S3) heat-treating the composite nanofibers, thus removing the organic material. In the spinel lithium titanium oxide nanofibers for a negative electrode of a lithium secondary battery prepared using the method according to the present invention, the spinel lithium titanium oxide nanofibers can provide a large surface area per unit volume, thus increasing the contact area between the electrolyte and the conductor and decreasing the lithium ion diffusion distance, thereby greatly contributing to improving electronic conductivity and ionic conductivity.

### BACKGROUND OF THE INVENTION

1. Field of the Invention

The present invention relates to a method of preparing a negative active material for a lithium secondary battery, and, more particularly, to a method of preparing spinel lithium titanium oxide in a nanofiber form as the negative active material.

2. Description of the Related Art

Secondary batteries are being used as large power storage batteries for electric vehicles or battery power storage systems, and small high-performance energy sources for portable electronic devices such as mobile phones, camcorders, notebooks, etc.

Recently, in the market for secondary batteries, high energy density and high output of power devices have been required because of the combined use of conventional portable electronic devices, and the size thereof has a tendency of increasing so as to be adapted for green homes, hybrid vehicles (HEV or PHEV), etc.

Batteries, which have to have high energy density and high output, are secondary batteries which should have remarkably enhanced specifications in terms of lifetime safety, and may thus be utilized as next-generation large power devices.

A negative material for the next-generation battery is typically exemplified by spinel lithium titanium oxide (Li₄Ti₅O₁₂) . Although the biggest advantages of spinel lithium titanium oxide (Li₄Ti₅O₁₂) are known to be high reversibility and high stability, as well as zero-strain properties which enable intercalation/de-intercalation of Li⁺ without changes in the parent structure, the initial oxidation state of Ti is actually +4 (3d⁰ configuration), thus exhibiting insulating characteristics having very low electronic conductivity. In order to solve the drawbacks of spinel lithium titanium oxide (Li₄Ti₅O₁₂), the spinel lithium titanium oxide (Li₄Ti₅O₁₂) is controlled in the form of nanofibers to increase the contact area between the electrolyte and the conductor, which plays an important role in improving lithium ionic conductivity and electronic conductivity.

The present inventors have paid attention to the preparation of nanofibers so that spinel lithium titanium oxide (Li₄Ti₅O₁₂) may provide a large surface area per unit volume, thus increasing the contact area between the electrolyte and the conductor and reducing the lithium ion diffusion distance, thereby manufacturing an electrode material having high lithium ionic conductivity or electronic conductivity, ultimately improving electrochemical properties at high current density corresponding to the drawback of Li₄Ti₅O₁₂, which culminated in the present invention.

### CITATION LIST

### Patent Literature

(Patent Document 1) Korean Unexamined Patent Publication No. 10-2012-0015293

(Patent Document 2) Korean Unexamined Patent Publication No. 10-2009-0011219

### SUMMARY OF THE INVENTION

Accordingly, the present invention has been made keeping in mind the above problems encountered in the related art, and an object of the present invention is to provide a method of preparing spinel lithium titanium oxide nanofibers for a negative electrode of a lithium secondary battery, wherein the spinel lithium titanium oxide nanofibers may provide a large surface area per unit volume, thus increasing the contact area between the electrolyte and the conductor and decreasing the lithium ion diffusion distance, thereby improving electronic conductivity and ionic conductivity.

Another object of the present invention is to provide spinel lithium titanium oxide nanofibers for a negative electrode of a lithium secondary battery, prepared using the above method, a negative electrode comprising the same and a lithium secondary battery.

In order to accomplish the above objects, the present invention provides a method of preparing spinel lithium titanium oxide nanofibers for a negative electrode of a lithium secondary battery, comprising (S1) mixing an organic material selected from the group consisting of polyvinylpyrrolidone, polymethylmethacrylate, polyethylene, polyethylene oxide and polyvinyl alcohol, a lithium precursor, and a titanium precursor with a solvent, thus preparing a mixture solution; (S2) electrospinning the mixture solution, thus preparing composite nanofibers; and (S3) heat-treating the composite nanofibers, thus removing the organic material.

The lithium precursor may be selected from the group consisting of, for example, lithium acetate dihydrate, lithium hydroxide and lithium nitrate.

The titanium precursor may be selected from the group consisting of, for example, titanium isopropoxide and titanium(IV) butoxide.

The solvent may be selected from the group consisting of, for example, methanol, ethanol, propanol, butanol and glycol.

In S1, the organic material may be added in an amount of 5˜12 wt % based on the weight of the solvent.

In S1, the lithium precursor may be added in an amount of 1˜10 wt % based on the weight of the solvent.

In S1, the titanium precursor may be added in an amount of 5˜40 wt % based on the weight of the solvent.

The electrospinning may be performed using a nozzle having a size ranging from 15 gauge to 30 gauge.

The electrospinning may be performed by applying a voltage of 1˜3 kV/cm.

The heat-treating in S3 may be performed at 700˜900° C.

The heat-treating in S3 may be performed in an oxidizing atmosphere.

The oxidizing atmosphere may be an air atmosphere or an oxygen atmosphere.

In addition, the present invention provides spinel lithium titanium oxide nanofibers for a negative electrode of a lithium secondary battery, prepared using the above method.

In addition, the present invention provides a negative electrode of a lithium secondary battery, comprising the above spinel lithium titanium oxide nanofibers.

In addition, the present invention provides a lithium secondary battery, comprising the above negative electrode.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates X-ray diffusion analysis results of spinel lithium titanium oxide (Li₄Ti₅O₁₂) nanofibers of Example 1 and spinel lithium titanium oxide (Li₄Ti₅O₁₂) nanoparticles as a control;

FIG. 2 illustrates scanning electron microscope (SEM) and transmission electron microscope (TEM) analysis results to analyze the form and crystal lattice of the spinel lithium titanium oxide (Li₄Ti₅O₁₂) nanofibers of Example 1;

FIG. 3a is a graph illustrating the results of measuring charge-discharge properties upon charge and discharge between 1 V and 3 V at C/10 of a half battery manufactured using the spinel lithium titanium oxide (Li₄Ti₅O₁₂) nanofibers of Example 1 as a negative active material;

FIG. 3b is a graph illustrating the results of measuring charge-discharge properties upon 50 cycles of charge and discharge between 1 V and 3 V at C/10 of the half battery manufactured using the spinel lithium titanium oxide (Li₄Ti₅O₁₂) nanofibers of Example 1 as the negative active material;

FIG. 3c is a graph illustrating the results of measuring charge-discharge properties upon charge and discharge between 1 V and 3 V at C/10, C/5, and 10C of the half battery manufactured using the spinel lithium titanium oxide (Li₄Ti₅O₁₂) nanofibers of Example 1 as the negative active material; and

FIG. 3d is a graph illustrating the results of measuring properties based on a galvanostatic intermittent titration technique (GITT) which shows polarization due to overvoltage during charge between 1 V and 3 V at 0.1C of the half battery manufactured using the spinel lithium titanium oxide (Li₄Ti₅O₁₂) nanofibers of Example 1 as the negative active material.

### DESCRIPTION OF SPECIFIC EMBODIMENTS

Hereinafter, a detailed description will be given of the present invention.

The present invention pertains to a method of preparing spinel lithium titanium oxide nanofibers for a negative electrode of a lithium secondary battery, wherein the spinel lithium titanium oxide nanofibers are prepared using electrospinning based on a sol-gel method.

According to the present invention, the method of preparing the spinel lithium titanium oxide nanofibers for a negative electrode of a lithium secondary battery includes (S1) mixing an organic material selected from the group consisting of polyvinylpyrrolidone, polymethylmethacrylate, polyethylene, polyethylene oxide and polyvinyl alcohol, a lithium precursor, and a titanium precursor with a solvent, thus preparing a mixture solution; (S2) electrospinning the mixture solution, thus preparing composite nanofibers; and (S3) heat-treating the composite nanofibers, thus removing the organic material.

In the method according to the present invention, the organic material selected from the group consisting of polyvinylpyrrolidone, polymethylmethacrylate, polyethylene, polyethylene oxide and polyvinyl alcohol, the lithium precursor, and the titanium precursor may be mixed with the solvent, thus preparing the mixture solution (S1).

The lithium precursor may include lithium acetate dihydrate, lithium hydroxide or lithium nitrate.

The titanium precursor may be selected from the group consisting of, for example, titanium isopropoxide and titanium(IV) butoxide.

The solvent may include, for example, an alcohol, such as methanol, ethanol, propanol, butanol, glycol, etc., and a polar solvent which may participate in hydrogen bonding.

The solvent is volatilized by means of electrospinning which will be described later, and the organic material is allowed to maintain the form of nanofibers by virtue of strength and elasticity after electrospinning.

The amount of the added organic material is preferably set to 5˜12 wt % based on the weight of the solvent. If the amount of the added organic material exceeds the upper limit of the above range, the thickness of the nanofibers may excessively increase, or the mixture solution may become hard before being introduced into a nozzle. In contrast, if the amount thereof is less than the lower limit of the above range, beads may be formed or nanopowder may be undesirably prepared, instead of the nanofibers.

The amount of the added lithium precursor is preferably set to 1˜10 wt % based on the weight of the solvent. If the amount of the added lithium precursor exceeds the upper limit of the above range, it may not completely dissolve in the mixture solution. In contrast, if the amount thereof is less than the lower limit of the above range, it is impossible to maintain the form of the nanofibers after heat treatment.

The amount of the added titanium precursor is preferably set to 5˜40 wt % based on the weight of the solvent. If the amount of the added titanium precursor exceeds the upper limit of the above range, it may not completely dissolve in the mixture solution. In contrast, if the amount thereof is less than the lower limit of the above range, it is impossible to maintain the form of the nanofibers after heat treatment.

In this step, acetic acid may be further added to prevent deposition of the titanium precursor. As such, the amount of added acetic acid is preferably set to 5˜30 vol % based on the volume of ethanol. If the amount of added acetic acid exceeds 30 vol %, the viscosity of the solution may vary over time. In contrast, if the amount thereof is less than 5 vol %, the deposition of the titanium precursor undesirably cannot be prevented.

Subsequently, the mixture solution is electrospun, thus preparing the composite nanofibers (S2).

The electrospinning is preferably performed using a nozzle having a size ranging from 15 gauge to 30 gauge. If the size of the nozzle exceeds the upper limit of the above range, nanopowder may be undesirably prepared, instead of the nanofibers. In contrast, if the size thereof is less than the lower limit of the above range, the thickness of the nanofibers may undesirably increase.

The electrospinning is preferably carried out by applying a voltage of 1˜3 kV/cm. If the voltage exceeds the upper limit of the above range, nanofibers of several strands may be extruded from the nozzle, and nanofibers having a severe thickness deviation may be undesirably prepared. In contrast, if the voltage is less than the lower limit of the above range, the solvent may not efficiently evaporate from the mixture solution extruded from the nozzle, making it impossible to prepare nanofibers.

Subsequently, the composite nanofibers are heat-treated, thus calcining the organic material (S3).

In this step, the heat treatment temperature is preferably set to 700˜900° C. If the heat treatment temperature exceeds the upper limit of the above range, fiber nano-particles may aggregate or the nanofibers may be severed. In contrast, if the heat treatment temperature is less than the lower limit of the above range, crystallinity of the spinel lithium titanium oxide may become poor.

Further, heat treatment is preferably carried out in an oxidizing atmosphere, and the oxidizing atmosphere may be an air atmosphere or an oxygen atmosphere.

A better understanding of the present invention may be obtained via the following examples which are set forth to illustrate, but are not to be construed as limiting, the present invention. Those skilled in the art will appreciate that various modifications and substitutions are possible, without departing from the scope and spirit of the invention as disclosed in the accompanying claims.

### Example 1

### Spinel Lithium Titanium Oxide (Li₄Ti₅O₁₂) Nanofibers

0.134 g of lithium acetate dihydrate and 0.466 g of titanium isopropoxide were mixed with 0.3 g of polyvinylpyrrolidone, and the resulting mixture was stirred, thus obtaining a homogeneous mixture solution. 4 ml of ethanol was used as the solvent.

To prevent deposition of the titanium precursor, acetic acid was added in an amount of 25 vol % based on the volume of ethanol.

Subsequently, the mixture solution was electrospun, thus preparing nanofibers. The electrospinning was performed under conditions including a rate of extrusion of the mixture solution of 0.5 ml/h, a voltage of 1˜3 kV/cm, a distance between the needle and the aluminum foil of 13 cm, and a thickness of the needle of 27 gauge.

The electrospun composite nanofibers were calcined at 750° C. for 3 hr in an oxidizing atmosphere to remove the organic material, thus completing spinel lithium titanium oxide (Li₄Ti₅O₁₂) nanofibers according to the present invention.

### Example 2

### Spinel Lithium Titanium Oxide (Li₄Ti₅O₁₂) Nanofibers

0.134 g of lithium acetate dihydrate and 0.466 g of titanium isopropoxide were mixed with 0.2 g of polyvinylpyrrolidone (4 wt % relative to the solvent), and the resulting mixture was stirred, thus obtaining a homogeneous mixture solution. 4 ml of ethanol was used as the solvent.

To prevent deposition of the titanium precursor, acetic acid was added in an amount of 25 vol % based on the volume of ethanol.

Subsequently, the mixture solution was electrospun, thus preparing nanofibers. The electrospinning was performed under conditions including a rate of extrusion of the mixture solution of 0.5 ml, a voltage of 1˜3 kV/cm, a distance between the needle and the aluminum foil of 13 cm, and a thickness of the needle of 27 gauge.

The electrospun composite nanofibers were calcined at 750° C. for 3 hr in an oxidizing atmosphere to remove the organic material, thus completing spinel lithium titanium oxide (Li₄Ti₅O₁₂) nanofibers according to the present invention.

### Example 3

### Spinel Lithium Titanium Oxide (Li₄Ti₅O₁₂) Nanofibers

0.134 g of lithium acetate dihydrate and 0.466 g of titanium isopropoxide were mixed with 0.7 g of polyvinylpyrrolidone (14 wt % relative to the solvent), and the resulting mixture was stirred, thus obtaining a homogeneous mixture solution. 4 ml of ethanol was used as the solvent.

To prevent deposition of the titanium precursor, acetic acid was added in an amount of 25 vol % based on the volume of ethanol.

Subsequently, the mixture solution was electrospun, thus preparing nanofibers. The electrospinning was performed under conditions including a rate of extrusion of the mixture solution of 0.5 ml, a voltage of 1˜3 kV/cm, a distance between the needle and the aluminum foil of 13 cm, and a thickness of the needle of 27 gauge.

The electrospun composite nanofibers were calcined at 750° C. for 3 hr in an oxidizing atmosphere to remove the organic material, thus completing spinel lithium titanium oxide (Li₄Ti₅O₁₂) nanofibers according to the present invention.

### Test Example 1

### X-ray Diffraction Analysis

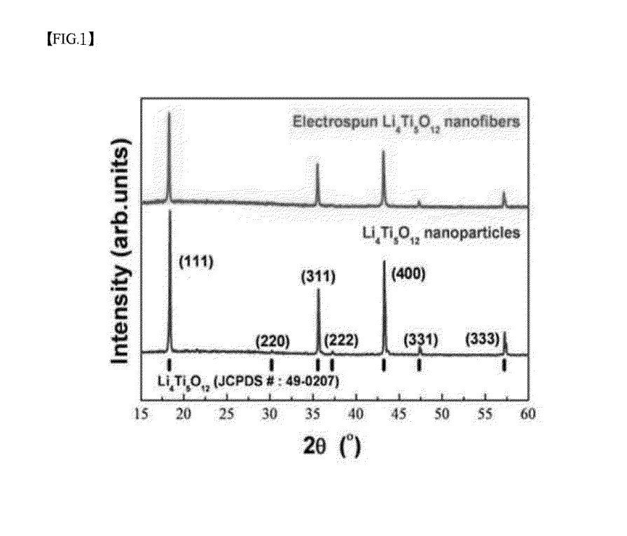

In order to analyze the structure of the spinel lithium titanium oxide (Li₄Ti₅O₁₂) nanofibers prepared in Example 1, the nanofibers were subjected to X-ray diffraction analysis, along with spinel lithium titanium oxide (Li₄Ti₅O₁₂) nanoparticles as the control. The results are illustrated in FIG. 1.

As illustrated in FIG. 1, the spinel lithium titanium oxide (Li₄Ti₅O₁₂) nanoparticles showed specific peaks at 18.331° (111), 30.181° (220), 35.571° (331), 37.212° (222), 43.242° (400), 47.352° (331), and 57.213° (333). Also, the spinel lithium titanium oxide (Li₄Ti₅O₁₂) nanofibers according to the present invention showed specific peaks at angles of 2θ, as in the spinel lithium titanium oxide (Li₄Ti₅O₁₂) nanoparticles.

As is apparent from the above results, the spinel lithium titanium oxide (Li₄Ti₅O₁₂) nanofibers according to the present invention can be confirmed to have the same structure as the spinel lithium titanium oxide (Li₄Ti₅O₁₂) nanoparticles.

### Test Example 2

### SEM and TEM Analysis

In order to analyze the form and crystal lattice of the spinel lithium titanium oxide (Li₄Ti₅O₁₂) nanofibers prepared in Example 1, the nanofibers were analyzed using a SEM and a TEM. The results are illustrated in FIG. 2.

As illustrated in FIGS. 2a and 2b, the spinel lithium titanium oxide (Li₄Ti₅O₁₂) is clearly provided in the form of nanofibers, and FIG. 2c illustrates the [111] crystal growth plane of lithium titanium oxide (Li₄Ti₅O₁₂). wherein the interplanar distance is 4.83 Å, corresponding to the lithium titanium oxide (Li₄Ti₅O₁₂).

FIG. 2d illustrates the selected-area electron diffraction pattern (SAED) of the spinel lithium titanium oxide (Li₄Ti₅O₁₂) nanofibers, which coincides with the crystal planes represented in the X-ray diffraction analysis in FIG. 1.

As is apparent from the above results, the spinel lithium titanium oxide (Li₄Ti₅O₁₂) nanofibers according to the present invention are clearly provided in the form of nanofibers, and the crystal lattice structure thereof is the same as in the spinel lithium titanium oxide (Li₄Ti₅O₁₂) nanoparticles.

### Test Example 3

### Charge-Discharge Curve and Coulombic Efficiency Analysis

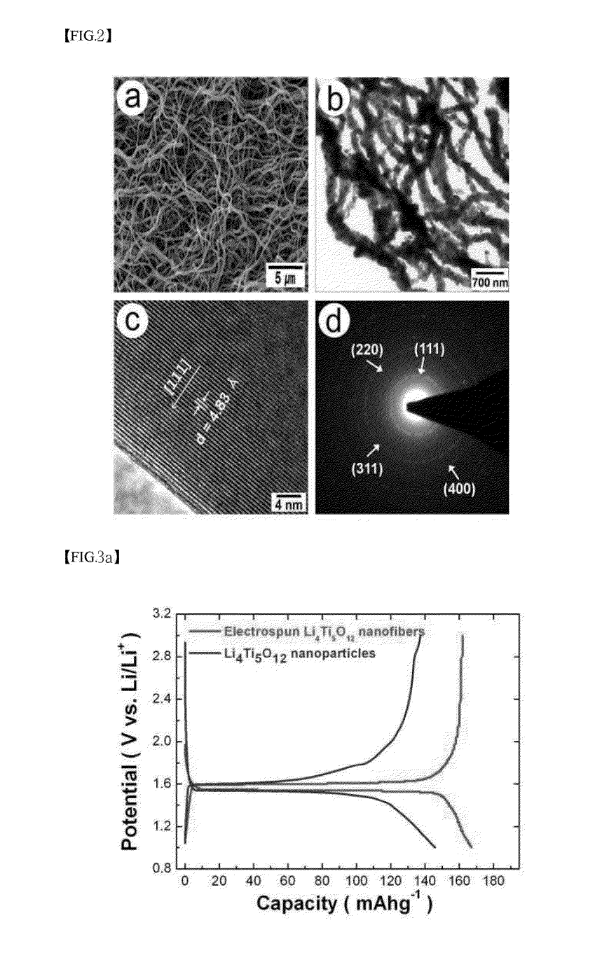

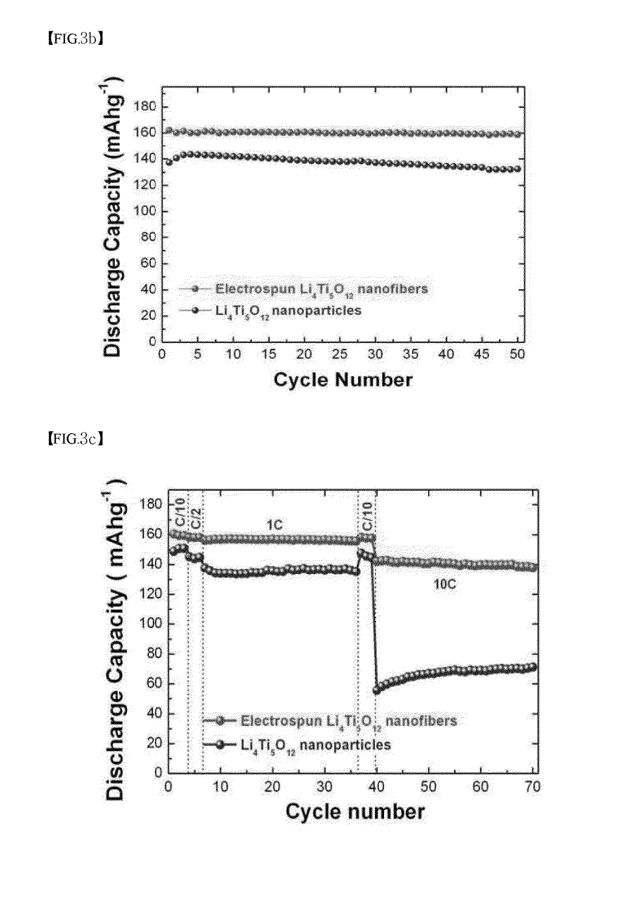

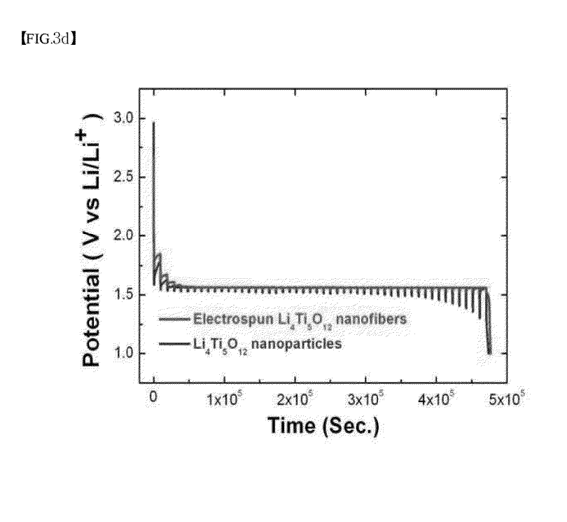

A half battery manufactured using the spinel lithium titanium oxide (Li₄Ti₅O₁₂) prepared in Example 1 as the negative active material was subjected to charge and discharge between 1 V and 3 V at C/10. The measurement results of the charge-discharge properties thereof are illustrated in FIG. 3a. Also, 50 cycles of charge and discharge were performed between 1 V and 3 V at C/10. The measurement results of the charge-discharge properties thereof are illustrated in FIG. 3b. In addition, charge and discharge were conducted between 1 V and 3 V at C/10, C/5, and 10C. The measurement results of the charge-discharge properties thereof are illustrated in FIG. 3c.

Further, a galvanostatic intermittent titration technique (GITT) which shows polarization due to overvoltage during charge between 1 V and 3 V at 0.1C was carried out. The measurement results of the properties thereof are illustrated in FIG. 3d.

As illustrated in FIG. 3a, the spinel lithium titanium oxide (Li₄Ti₅O₁₂) nanofibers of Example 1 manifested the oxidation/reduction as in the spinel lithium titanium oxide Li₄Ti₅O₁₂), and exhibited higher capacity compared to the spinel lithium titanium oxide (Li₄Ti₅O₁₂).

With reference to FIG. 3b, when repeating 50 cycles of charge and discharge at C/10 in the lithium ion battery, the spinel lithium titanium oxide (Li₄Ti₅O₁₂) nanofibers exhibited superior capacity properties, compared to the spinel lithium titanium oxide (Li₄Ti₅O₁₂), and also, the capacity retention was 98.14% upon C/10 charge and discharge even after 50 cycles of charge and discharge, resulting in high lifetime properties.

With reference to FIG. 3c, to evaluate changes in capacity of the spinel lithium titanium oxide (Li₄Ti₅O₁₂) nanofibers prepared in the above example at different discharge rates, the discharge curve was analyzed. The results are shown in FIG. 3c. The discharge curve of the spinel lithium titanium oxide (Li₄Ti₅O₁₂) as the control is also depicted in FIG. 3c.

As illustrated in FIG. 3c, the capacity of the spinel lithium titanium oxide (Li₄Ti₅O₁₂) as the control was remarkably decreased as the discharge rate (C-rate) was increased from C/10 to 10C, and the capacity thereof was about 70 mAh/g at 10C. However, the extent of decrease of the capacity of the spinel lithium titanium oxide (Li₄Ti₅O₁₂) nanofibers according to the present invention in proportion to an increase in the discharge rate was reduced, and high output properties retained to about 140 mAh/g at 10C were represented.

With reference to FIG. 3d, in the galvanostatic titration curves, the spinel lithium titanium oxide (Li₄Ti₅O₁₂) nanofibers had lower polarization compared to the spinel lithium titanium oxide (Li₄Ti₅O₁₂) as the control, thus increasing conductivity of Li⁺.

Thereby, the spinel lithium titanium oxide (Li₄Ti₅O₁₂) nanofibers according to the present invention may provide a larger surface area per unit volume compared to the spinel lithium titanium oxide (Li₄Ti₅O₁₂) as the control, thus exhibiting improved electronic conductivity and ionic conductivity. Hence, the nanofibers according to the present invention can be suitable for use as the negative material for a lithium secondary battery, which is very favorable in high-speed charge and discharge upon charge and discharge.

On the other hand, in Example 2, non-uniform nanofibers were prepared due to low viscosity, and thus the electrochemical properties thereof were evaluated to be inferior. In Example 3, it was difficult to prepare the uniform mixture solution because of high viscosity of the total solution with the excessive addition of the organic material, and the solution became hard over time. Therefore, upon preparation of the spinel lithium titanium oxide (Li₄Ti₅O₁₂) nanofibers according to the present invention, it is preferred that the addition of the organic material be adjusted in the appropriate range relative to the solvent.

As described hereinbefore, the present invention provides a method of preparing spinel lithium titanium oxide nanofibers for a negative electrode of a lithium secondary battery. In the spinel lithium titanium oxide nanofibers prepared using the method according to the present invention, the spinel lithium titanium oxide nanofibers can provide a large surface area per unit volume, thus increasing the contact area between the electrolyte and the conductor and decreasing the lithium ion diffusion distance, thereby greatly contributing to improvements in electronic conductivity and ionic conductivity.

1. A method of preparing spinel lithium titanium oxide nanofibers for a negative electrode of a lithium secondary battery, comprising:
(S1) mixing an organic material selected from the group consisting of polyvinylpyrrolidone, polymethylmethacrylate, polyethylene, polyethylene oxide and polyvinyl alcohol, a lithium precursor, and a titanium precursor with a solvent, thus preparing a mixture solution;
(S2) electrospinning the mixture solution, thus preparing composite nanofibers; and
(S3) heat-treating the composite nanofibers, thus removing the organic material.

2. The method of claim 1, wherein the lithium precursor is selected from the group consisting of lithium acetate dihydrate, lithium hydroxide and lithium nitrate.

3. The method of claim 1, wherein the titanium precursor is selected from the group consisting of titanium isopropoxide and titanium(IV) butoxide.

4. The method of claim 1, wherein the solvent is selected from the group consisting of methanol, ethanol, propanol, butanol and glycol.

5. The method of claim 1, wherein in S1, the organic material is added in an amount of 5˜12 wt % based on a weight of the solvent.

6. The method of claim 1, wherein in S1, the lithium precursor is added in an amount of 1˜10 wt % based on a weight of the solvent.

7. The method of claim 1, wherein in S1, the titanium precursor is added in an amount of 5˜40 wt % based on a weight of the solvent.

8. The method of claim 1, wherein the electrospinning is performed using a nozzle having a size ranging from 15 gauge to 30 gauge.

9. The method of claim 1, wherein the electrospinning is performed by applying a voltage of 1˜3 kV/cm.

10. The method of claim 1, wherein the heat-treating in S3 is performed at 700˜900° C.

11. The method of claim 1, wherein the heat-treating in S3 is performed in an oxidizing atmosphere.

12. The method of claim 11, wherein the oxidizing atmosphere is an air atmosphere or an oxygen atmosphere.

13. Spinel lithium titanium oxide nanofibers for a negative electrode of a lithium secondary battery, prepared using the method of claims 1.

14. A lithium secondary battery, comprising the negative electrode comprising the spinel lithium titanium oxide nanofibers of claim 13.

15. (canceled)
